(19) United States
(12) Patent Application Publication
(10) Pub. No.: US 2025/0048513 A1
(43) Pub. Date: Feb. 6, 2025

(54) LIGHTING DEVICE FOR VEHICLE INTERIOR LIGHTING

(71) Applicant: Lisa Dräxlmaier GmbH, Vilsbiburg (DE)

(72) Inventors: Josef KIERMAIER, Unterdietfurt (DE); Nico SCHNEUCKER, München (DE)

(73) Assignee: Lisa Dräxlmaier GmbH, Vilsbiburg (DE)

(21) Appl. No.: 18/920,017

(22) Filed: Oct. 18, 2024

Related U.S. Application Data
(63) Continuation of application No. PCT/EP2023/059916, filed on Apr. 17, 2023.

(30) Foreign Application Priority Data
Apr. 22, 2022 (DE) 10 2022 109 518.5

(51) Int. Cl. H05B 45/10; B60Q 3/85; H05B 45/325; H05B 45/345

(52) U.S. Cl. CPC H05B 45/10; B60Q 3/85; H05B 45/325; H05B 45/345

(57) ABSTRACT

A lighting device for vehicle interior lighting including at least one dimmable light source, a current driver supplying the at least one dimmable light source with a control current and a microcontroller to determine a dimming value for dimming the at least one light source corresponding to a dimming request signal and to transfer this to the current driver. The at least one light source has a brightness, which corresponds to the control current. The current driver is to set the control current for supplying the at least one light source corresponding to the dimming value so that the at least one light source assumes the brightness corresponding to the dimming value. The microcontroller is to determine the dimming value as a new dimming value based on a current dimming value and a dimming value change. The dimming value change is based on the dimming request signal.

### CROSS-REFERENCE TO RELATED APPLICATIONS

This application is a continuation of International Application No. PCT/EP2023/059916, filed on Apr. 17, 2023, which claims priority to and the benefit of DE 10 2022 109 518.5 filed on Apr. 20, 2022. The disclosures of the above applications are incorporated herein by reference.

### FIELD

The present disclosure relates to the field of vehicle lighting, in particular, the present disclosure relates to a lighting device for vehicle interior lighting and a process for dimming a lighting device for vehicle interior lighting.

### BACKGROUND

The statements in this section merely provide background information related to the present disclosure and may not constitute prior art.

Ambient and functional lighting in vehicle interiors is often designed to be dimmable. In order for the human eye to perceive a dimming process as smooth and continuous, the light intensity of the lighting must be changed logarithmically. This is technically achieved by logarithmically changing the electrical current via the light source. A large amount of memory may be used to achieve this logarithmic control and store the logarithmic characteristic curve on the microcontroller. Calculating the logarithmic characteristic curve using the power law on the microcontroller may use a high computing power and a large amount of memory. Additionally, these known implementations have the disadvantage that, with low light intensity and limited resolution of brightness levels, no changes in brightness of the LED are visible and thus the user does not receive any direct feedback from the lighting system.

### SUMMARY

This section provides a general summary of the disclosure and is not a comprehensive disclosure of its full scope or all of its features.

The present disclosure provides a dimmable lighting of the vehicle interior, in particular, with which the disadvantages mentioned above can be overcome.

In particular, the present disclosure provides a dimmable vehicle interior lighting which uses low computing and memory resources and can reliably perform dimming, so that changes in LED brightness are perceptible by the user even at low light intensity. Generally, present disclosure relates to ambient lighting and vehicle interior lighting by means of light emitting diodes (LEDs) and other light sources.

The present disclosure generates this logarithmic control that uses particularly low memory and calculation in the control circuit (control IC) of the lighting system.

The control IC receives the dimming request from the user externally. By means of the dimming routine, it calculates a brightness signal that changes with time, which is used in the downstream current driver to supply an LED. This dimming routine is particularly efficient, as it can calculate the future value from the current value iteratively, and in particular avoids computationally intensive multiplication and exponentiation. Memory for saving the total characteristic curve on the microcontroller may be omitted here. With low-cost microcontrollers as control ICs, memory space and computational power may be limited.

The new dimming routine avoids the computationally intensive evaluation of the power law through a simplification which only uses addition and subtraction and bit shifting as operators, but avoids computationally intensive multiplication and exponentiation. Additionally, the new dimming routine is configured such that the change in light intensity during the dimming process is large enough at all times to be perceived and thus the lighting always reacts directly to the user request with a change in light intensity. With exact calculation using the logarithmic law and limited PWM accuracy, this is not always the case in a conventional system because rounding processes are desired for control on a real microcontroller. As a result, the logarithmic characteristic curve that is implemented on a microcontroller does not generate any changes in brightness on the controlled LED at the beginning of the dimming process.

The dimming routine presented here does not have this disadvantage. The characteristic curve of the dimming routine deviates slightly from exact logarithmic behavior, however the human eye cannot consciously recognize this. The exact logarithmic behavior can be expressed in the form of dimming value(t)=αβ^{t}, for example.

The dimming routine presented here can be very easily transferred to all LEDs and lighting products which are dimmed using PWM or linear constant current control. This makes it possible to use smaller and more cost-effective microcontrollers. With the dimming routine presented here, memory and computation capacity can be saved in comparison to typical control circuits.

Additionally, the solution presented here has the advantage that changes in brightness are visible on the LED even at low light intensity, giving the user direct feedback from the lighting system.

According to a first aspect, the present disclosure provides a lighting device for vehicle interior lighting having: at least one dimmable light source; a current driver for supplying the at least one dimmable light source with a control current, with which the at least one light source assumes a brightness which corresponds to the control current; and a microcontroller which is designed to determine a dimming value for dimming the at least one light source corresponding to a dimming request signal and to transfer this to the current driver, wherein the current driver is configured to set the control current for supplying the at least one light source corresponding to the dimming value so that the at least one light source assumes a brightness corresponding to the dimming value, wherein the microcontroller is configured to determine the dimming value as a new dimming value based on a current dimming value and a dimming value change, wherein the dimming value change is based on the dimming request signal.

Such a lighting device offers the technical advantage that memory and computing capacity can be saved in comparison to conventional dimming devices. This enables the use of smaller and more cost-effective microcontrollers. The dimming routine presented above implemented in the microcontroller, in which the new dimming value is determined based on the current dimming value and a dimming value change, is particularly efficient, as it can calculate the future value iteratively from the current value. Storage for saving the entire characteristic curve on the microcontroller are not needed here. The new dimming routine avoids the computationally intensive evaluation of the power law through a simplification which only uses addition and subtraction and bit shifting as operators, but avoids computationally intensive multiplication and exponentiation.

According to one example of the lighting device, the microcontroller is configured to determine a new dimming value when the dimming request signal is given, wherein the new dimming value differs from the current dimming value and causes a change in the brightness of the at least one light source, which can be perceived in particular by a user.

Thus the technical advantage is achieved that a perceptible change in brightness of the at least one light source is visible even at low light intensity and thereby providing the user with direct feedback from the lighting device.

According to one exemplary example of the lighting device, the dimming value follows a non-logarithmic time curve.

This has the technical advantage that, in contrast to the logarithmic curve, where low light intensity or small dimming values per dimming step result in a small change in brightness which leads to the same dimming value being maintained over several steps due to rounding and/or resolution limitations on the microcontroller and the dimming process is therefore not perceptible to the user, the non-logarithmic curve does not result in any such disadvantageous effects. Every dimming step results in a change of brightness which is perceptible to the user. The non-logarithmic curve can, for example, represent a step-by-step linear approximation of the logarithmic curve, in which every step results in a change in brightness.

According to one example of the lighting device, the dimming value change is based on an addition or subtraction as well as a bit shifting.

This has the technical advantage that memory space and computing capacity can be saved if only addition, subtraction, or shifting operations must be performed. This allows the microcontroller to be smaller and more cost-effective.

According to one example of the lighting device, the dimming value change comprises integer changes of the dimming value in the positive or negative direction.

This has the advantage that both dimming up as well as dimming down can be realized, and that there is a change in brightness in each dimming step.

According to one example of the lighting device, the microcontroller is configured to determine the dimming value change based on the current dimming value and one or more predefined dimming value parameters.

This has the advantage that no unknowns need to be determined due to the predefined parameters, for example based on the solution of equations or equation systems. The dimming value parameters are known here, and only one equation via which the new dimming value can be determined from the old dimming value and the known dimming value parameters is used. This makes it very easy to determine the new dimming value, so that the microcontroller can be configured in a simple manner, and in particular that very little memory and computing capacity is used in contrast to typical microcontrollers which are used in dimming devices.

According to one example of the lighting device, the microcontroller is configured to determine the dimming value change and the new dimming value based on the following relationships: Δs(t)=a−((b−dimming value(t))>>c), dimming value (t+1)=dimming value(t)±Δs(t), wherein “dimming value(t)” denotes the current dimming value, “dimming value (t+1)” denotes the new dimming value, “Δs(t)” denotes the current dimming value change, and “a”, “b”, and “c” denote the predefined dimming value parameters, and wherein “>>” denotes a rightward shift by a quantity of c bits, (t) denotes the current time step or dimming step, (t+1) represents the subsequent or new time step or dimming step.

This offers the advantage that the calculation can be performed during the runtime of the microcontroller. In particular, a faster calculation of the PWM step can thus be performed by avoiding the exponential operations of the current PWM step, and memory space can be saved by avoiding the storage of the entire logarithmic characteristic curve and by avoiding the storage of large floating point numbers.

According to one example of the lighting device, parameter a corresponds to a predefined maximum global brightness change between two dimming steps, parameter b is within the range of a predefined maximum dimming value, and parameter c is in a range around the value c=log₂(b/a).

For example, parameter b can be within a range from 50% to 100%, preferably in the range from 80% to 100%, of the predefined maximum dimming value. For example, parameter c can be within a range from 50% to 150%, preferably in the range from 80% to 120%, of the value c=log₂(b/a) as mentioned above.

This offers the advantage that the three dimming value parameters are easy to determine. For example, it is sufficient to know how large the maximum dimming value is and how large the maximum global brightness change between two dimming steps is in order to determine the three dimming value parameters.

According to one example of the lighting device, the at least one light source comprises one or more light emitting diodes.

This offers the advantage that light emitting diodes are now being used in many vehicle areas, offer high luminosity, and can be produced at low cost.

According to one example of the lighting device, the current driver is configured to adjust the control current for supplying the at least one light source based on pulse width modulation—PWM—wherein a portion of an on phase is determined by the dimming value at a total time.

This offers the advantage that the power to consumers such as light emitting diodes and other light sources can be regulated easily. Instead of controlling these parts and components via the level of the operating voltage and/or the operating current, pulse width modulation can simply be used to interrupt the voltage or current for a short time. This creates a specific relationship between voltage pulses and pauses which can be used to adjust the brightness of the light source.

According to one example of the lighting device, the current driver is configured to adjust the current flow for supplying the at least one light source according to a linear constant current control, and wherein an amplitude of the control current is based on the dimming value.

This offers the advantage that a simple alternative to power regulation using PWM can be realized. Analog dimming can therefore be implemented efficiently using an analog circuit, for example by means of a regulated current source, which can have a simple structure. For example, op-amps and other analog circuitry elements can be used for this purpose, which can be cost-effectively produced. An additional advantage in comparison to the PWM realization is flicker-free lighting, which can be realized with this method.

According to one example of the lighting device, the dimming request signal comprises a start signal or a stop signal, and the microcontroller is configured to continuously determine new dimming values in the presence of the start signal, and to leave the dimming value unchanged in the presence of the stop signal.

This offers the advantage that the lighting device can be simply and efficiently operated by the user. He or she only needs to enter the start signal and wait until the brightness approaches the desired level, and then actuate the stop signal.

According to one example of the lighting device, the start signal indicates dimming in the positive or negative direction, and the microcontroller is configured to determine the new dimming value based on the current dimming value and a positive dimming value change when dimming in a positive direction is indicated; and to determine the new dimming value based on the current dimming value and a negative dimming value change when negative dimming is indicated.

This offers the advantage that the microcontroller can execute the iterative dimming routine efficiently. This means that both dimming up as well as dimming down can be carried out efficiently.

According to one example of the lighting device, the dimming request signal comprises information concerning a proportional brightness level with regard to a maximum brightness level of the at least one light source and the microcontroller is configured to determine the dimming value corresponding to the proportional brightness level.

This offers the advantage that the lighting device can be simply and efficiently operated by the user. He or she only needs to enter the proportional brightness level and the microcontroller performs the iterative dimming routine until the desired brightness level is achieved. Of course, the user can also enter an absolute brightness level or another type of input of the desired brightness instead of the proportional brightness level.

According to one example of the lighting device, the lighting device is configured to receive the dimming request signal from an external source via a switch, a button, a user interface with a display, or via a signal line. Alternatively, the lighting device has an integrated sensor system, which is configured to detect a user input via a button, a switch, an integrated proximity sensor system, touch sensor system, and/or force sensor system, and to transform it into the dimming request signal.

This offers the advantage of high flexibility for detecting the dimming request signal.

According to a second aspect of the present disclosure, the task described above is solved by a method for dimming a lighting device for vehicle interior lighting, having at least one dimmable light source and a current driver for supplying the at least one light source with a control current with which the at least one light source assumes a brightness level corresponding to the control current, wherein the process features the following steps: determining a dimming value for dimming the at least one light source; transferring the dimming value to the current driver; adjusting the control current for supplying the at least one light source by the current driver corresponding to the dimming value so that the at least one light source assumes a brightness which corresponds to the dimming value, wherein the new dimming value is determined based on a current dimming value and a dimming value change, wherein the dimming value change is based on a dimming request signal.

Such a method offers the same advantages as the lighting device described above. That is to say, memory space and computing capacity can be saved in comparison to typical dimming processes, and thus the use of smaller and more cost-effective microcontrollers becomes possible. The dimming routine with which the new dimming value is determined based on the current dimming value and a dimming value change, is particularly efficient, as it can calculate the future value from the current value iteratively. Memory is therefore not used to save the entire characteristic curve. The new dimming routine avoids the computationally intensive evaluation of the power law through a simplification which only uses addition and subtraction and bit shifting as operators, but avoids computationally intense multiplication and exponentiation.

According to a third aspect of the present disclosure, the task is solved by a computer program with a program code to perform the method according to the second aspect on a lighting device according to the first aspect.

This has the technical advantage that the computer program can be implemented easily on a lighting device, for example on the microprocessor and the current driver of the lighting device.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1A is a schematic representation of the structure of a lighting device for vehicle interior lighting according to the present disclosure;

FIG. 1B is a schematic representation of the structure of a lighting device for vehicle interior lighting according to the present disclosure, in which the current driver is integrated in the microcontroller;

FIG. 2 is a dimming curve according to the present disclosure in comparison to a typical dimming curve; and

FIG. 3 is a schematic representation of a method according to the present disclosure for dimming a lighting device for vehicle interior lighting.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

In the following detailed description, reference will be made to the accompanying illustrations forming a part thereof, in which specific examples in which the present disclosure can be carried out are shown by way of illustration. It is understood that other examples can be used and structural or logical changes can be made without deviating from the concept of the present disclosure. The following detailed description is therefore not to be understood in a limiting sense. Furthermore it is understood that the features of the various examples described herein can be combined with one another, unless specifically indicated otherwise.

The aspects and examples are described with reference to the illustrations, wherein the same reference numerals in general correspond to identical elements. In the following description, numerous specific details are presented for explanatory purposes in order to provide a thorough understanding of one or more aspects of the present disclosure. It may be apparent for a person skilled in the art, however, that one or multiple aspects or examples can be designed with a lower degree of specific detail. In other cases, known structures and elements are shown schematically in order to facilitate the description of one or more aspects or examples. It is understood that other examples can be used and structural or logical changes can be made without deviating from the concept of the present disclosure.

In the present disclosure, PWM or linearly dimmed light sources, in particular LEDs and OLEDs (organic LEDs) are described.

A light emitting diode (LED) is a semiconductor component which radiates light when electric current flows in the forward direction. The LED blocks the flow in the reverse direction. Thus the electrical properties of the LED correspond to those of a diode. The wavelength of the light emitted depends on the semiconductor material and the doping agent of the diode: The light can be visible to the human eye or in the range of infrared or ultraviolet radiation.

Pulse width modulation (PWM) is also known as pulse duration modulation (PDM) or pulse length modulation (PLM). Pulse width modulation (PWM) is a type of digital modulation in which a technical dimension (such as electrical voltage) switches between two values. At a constant frequency a square wave is modulated, the width or length of which varies. The relationship between impulse and pause is designated as the duty cycle.

In pulse duration modulation, the modulated signal has a predefined amplitude. Therefore the pulse duration depends on the amplitude of the information signal. The larger the information signal, the longer the pulse lasts.

Although the pulse width modulation signal is alternating voltage or mixed voltage, it can be used to regulate the power of direct current consumers such as light emitting diodes and other light sources. Instead of controlling these parts and components via the operating voltage level, the voltage or the current is interrupted for a short time using pulse width modulation. In this way a certain relationship between current pulses and pauses is created. The relationship determines the effective current and thus the brightness of the light source.

The present disclosure describes PWM drivers and, in general, current drivers used in dimming. With PWM drivers, the LED luminous flux or, more generally, the luminous flux of the light source is adjusted by changing the ON/OFF duty cycle. The frequency of a dimming PWM can, for example, be in the range of approximately 100 Hz, preferably in the range between 300 Hz and 1000 Hz, or even higher to avoid the stroboscopic effect upon switching the light source on or off.

Other methods can be used for dimming instead of PWM, such as linear constant current dimming. To this end, a regulated current source can be used, for example, which works by means of operational amplifiers and other analog circuit elements.

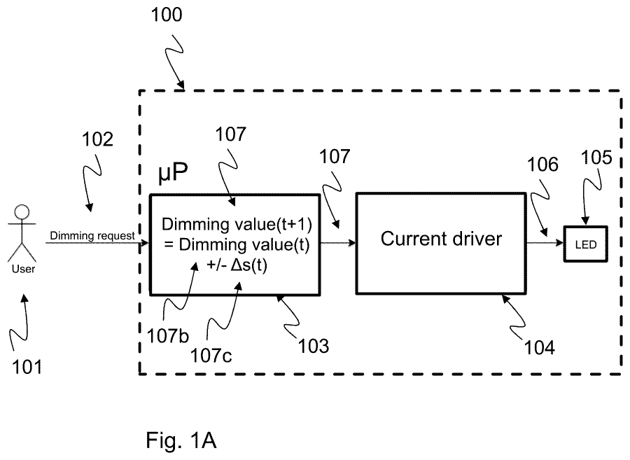

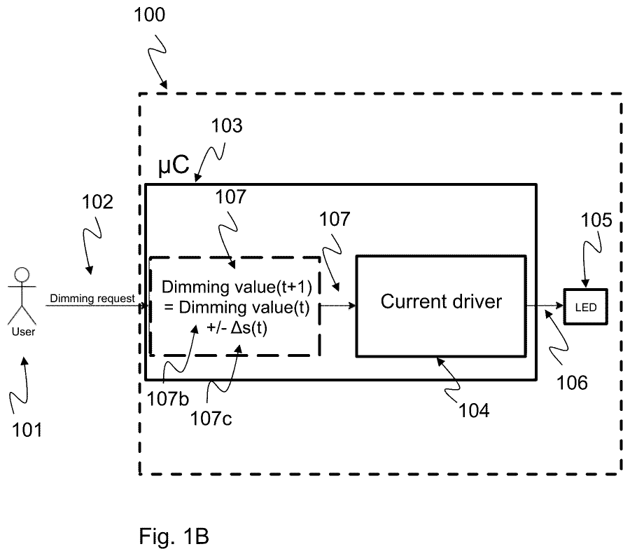

FIG. 1A schematically shows the construction of a lighting device 100 according to the present disclosure for vehicle interior lighting;

The lighting device 100 comprises at least one dimmable light source 105; a current driver 104 to supply the at least one dimmable light source 105 with a control current 106, with which the at least one light source 105 emits a luminous flux which corresponds to the control current 106 and thus assumes a corresponding brightness; and a microcontroller 103.

In response to a dimming request signal 102 the microcontroller 103 is designed or configured to determine a dimming value 107 for dimming the at least one light source 105 and transfer that value to the current driver 104.

The current driver 104 is configured to adjust the control current 106 for supplying the at least one light source 105 in response to the dimming value 107, so that the at least one light source 105 assumes a brightness corresponding to the dimming value 107.

The microcontroller 103 is configured to determine the new dimming value 107 based on a current dimming value 107b and a dimming value change 107c, wherein the dimming value change 107c is based on the dimming request signal 102.

The microcontroller 103 can be configured to determine a new dimming value 107 in the presence of a dimming request signal 102, where the new dimming value 107 differs from the current dimming value 107b and causes a change in brightness of the at least one light source 105, which is in particular perceptible by a user 101.

For example, the dimming value 107 can follow a non-logarithmic time curve, in particular a step-by-step linear approximation to a logarithmic time curve.

The dimming value change 107c can be based on, for example, an addition and/or subtraction and/or shifting operation. Thus the new dimming value at the time (t+1) can easily be determined from the current dimming value at the time (t) and the dimming direction. Only simple arithmetic operations such as addition and subtraction as well as bit shifting operations are needed for this purpose. The microcontroller 103 can have a very simple structure and may not use a large memory or computing power. Thus, for example, three memory cells are sufficient to store the three parameters a, b, and c, instead of the large number of N memory cells for every interpolation point when evaluating the logarithmic curve.

In an alternative example, as shown in FIG. 1B, the current driver 104 can be integrated in the microcontroller 103.

The dimming value change 107c can comprise, for example, integer changes of the dimming value 107 in the positive or negative direction. Dimming up is generated in the positive direction, and dimming down in the negative direction.

The microcontroller 103 is configured to determine the dimming value change based on the current dimming value 107b and one or more predefined dimming value parameters. These dimming value parameters determine how the new dimming value is determined from the current dimming value. The dimming value parameters can be previously predefined parameters that are known when determining the new dimming value is determined or saved in a constant memory. Although the dimming value parameters are predefined parameters, they can be updated during a system upgrade if desired.

A preferred variant of the lighting device 100 will subsequently be presented in more detail.

The microcontroller 103 can be configured to determine the dimming value change 107c based on, for example, the following relationship:

$$Δ s ( t ) = a - ( ( b - dimming value ( t ) ) ≫ c ) ,$$

wherein “dimming value(t)” denotes the current dimming value 107, “Δs(t)” denotes the dimming value change 107c, and “a”, “b”, and “c” denote the predefined dimming value parameters, and wherein “>>” denotes a shift to the right by a number of c bits.

The parameter a can correspond to a predefined maximum global brightness change between two dimming steps. The parameter b can be within the range of a predefined maximum dimming value. The parameter c can be in the range around the value c=log 2(b/a).

For example, parameter b can be within a range from 50% to 100%, preferably in the range from 80% to 100%, of the predefined maximum dimming value. For example, parameter c can be within the range from 50% to 150%, preferably in the range from 80% to 120%, of the value c=log 2(b/a) as mentioned above.

The at least one light source 105 can comprise, for example, one or more light emitting diodes (LEDs). The at least one light source 105 can furthermore comprise additional types of light sources, such as incandescent bulbs, fluorescent lamps, halogen lamps, glow lamps, laser diodes, lasers, OLEDs, electroluminescent foils, etc.

The current driver 104 can be configured to adjust the control current 106 for supplying the at least one light source 105 based on pulse width modulation—PWM—wherein a portion of an on phase of the PWM is determined by the dimming value 107 for a total time.

Alternatively, the current driver 104 can be configured to adjust the control current 106 for supplying the at least one light source 105 linearly. An amplitude of the control current 106 can hereby be based on the dimming value 107.

The dimming request signal 102 can comprise a start signal and/or a stop signal. The microcontroller 103 can be configured to determine a new dimming value 107 in the presence of the start signal and to leave the dimming value 107 unchanged in the presence of the stop signal.

The lighting device 100 can be configured to receive the dimming request signal 102 from an external source via a switch, a button, a user interface with a display, or via a signal line.

Alternatively, the lighting device can have an integrated sensor system, which can be designed to detect a user input via a button, a switch, an integrated proximity sensor system, touch sensor system, and/or force sensor system, and to transform it in the dimming request signal 102.

This allows the dimming request signal 102 to be detected by various means.

In one example of the lighting device 100, the dimming request signal 102 can be entered or actuated by the user 101. Thus the lighting device 100 can comprise a touch-sensitive area via which the user can make inputs, for example enter the start signal for the dimming process and/or the stop signal for the dimming process.

Alternatively, another input device can be attached to the lighting device with which the user 101 can make inputs for dimming.

Alternatively, the lighting device 100 can have an input interface with which the lighting device 100 can receive the dimming request signal 102, for example via a cable or also wirelessly.

The start signal can indicate, for example, dimming in the positive or negative direction.

The microcontroller 103 can be configured to determine the new dimming value 107 based on the current dimming value 107b and a positive dimming value change 107c when dimming in the positive direction is indicated; and to determine the new dimming value 107 based on the current dimming value 107b and a negative dimming value change 107c when dimming in the negative direction is indicated.

The dimming request signal 102 can, for example, comprise information concerning a proportional brightness level with respect to a maximum brightness of the light source 105 and the microcontroller 103 can be designed to determine the dimming value 107 corresponding to the proportional brightness level. Thus, for example, the microcontroller 103 can allow iterative dimming as described above to continue until the brightness of the light source 105 reaches the proportional brightness level of the maximum brightness. The same applies to dimming down in the opposite brightness direction.

Here as well, the dimming request signal 102 can be entered or actuated by the user 101. Thus the lighting device 100 can comprise an input device analogous to the screen of a smartphone, by means of which the user can enter the proportional brightness level. Alternatively, the proportional brightness level can also be received via an interface from another device, as described above, for example from a control panel in the cockpit of the vehicle, via which the user 101 can make his or her input.

The dimming request from the user can preferably be transmitted via a switch, a button, a UI (user interface) with a display (etc.) or directly to the lighting device 100 by means of a button, a switch, integrated proximity sensor system and/or touch sensor system and/or force sensor system. The dimming request signal 102 can thus be transmitted to the lighting device 100 from an external source or the lighting device 100 can itself receive user input by means of integrated sensor systems and thereby generate the dimming request.

Various examples of the dimming routine for controlling the at least one light source, in particular an LED, will be described below.

An LED can be controlled by means of PWM (pulse width modulation) during the dimming process. In this process, the LED is switched on and off at a high frequency. The current is hereby constant during the “on” phase. This is perceived by the human eye as reduced brightness, whereby the proportion of the “on” phase of the LED to the total time reflects the proportional brightness to the maximum brightness. Control takes place at the output of a microcontroller. A second variant is linear constant current dimming of the LED. Here the current is changed directly and set between off and maximum current during the dimming process. The algorithm presented here can be used for both variants.

The calculation algorithm presented here for the control of the LED is an iterative process. The previous value is used for calculating the next value in the dimming routine. The calculation is performed using the relationship:

$$Dimming value ( t + 1 ) = dimming value ( t ) \pm Δ s ( t , )$$

wherein the dimming value reflects the brightness of the LED at a point in time and Δs describes the change in brightness to the next point in time during the dimming process. Addition takes place when dimming up and subtraction when dimming down. The change in brightness Δs can be determined as follows:

$$Δ s ( t ) = a - ( ( b - dimming value ( t ) ) ≫ c )$$

Here a, b, and c are constant and a corresponds to the maximum brightness change between two time steps, b is within the range of the maximum dimming value, and c is in the rage of log 2(b/a). The operator “>>” describes a shift the right by c bits here.

The dimming value and the brightness change are whole-number values (integers). For example, the calculation algorithm for a dimming routine with a 10-bit integer (maximum value 1023) is presented in FIG. 1A.

The calculation is performed during the runtime of the microcontroller 103 and offers the following advantages:
1. Faster calculation of the PWM step by avoiding exponential calculations of the current PWM step.
2. Saving memory space by avoiding the storage of the entire logarithmic characteristic curve and by avoiding the storage of large floating point numbers.

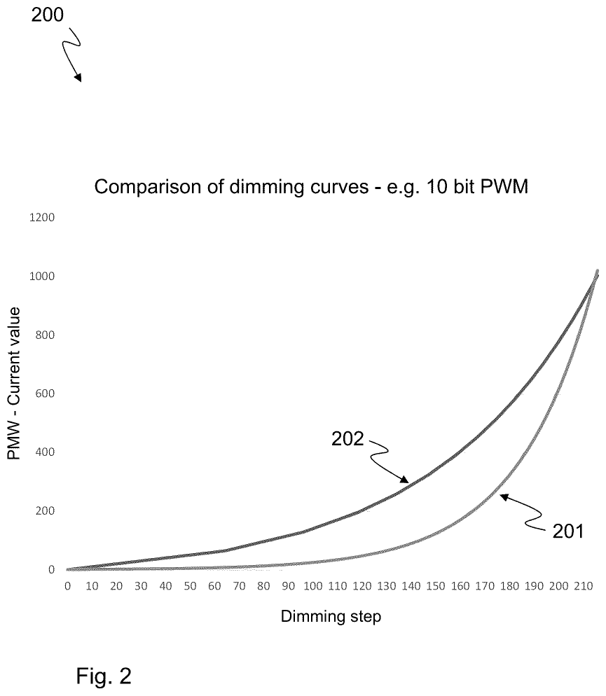

The dimming routine provides that Δ≥1. This means that the brightness is incremented in each dimming step. This is not necessarily achieved by the classic logarithmic characteristic curve with a limited discrete set of values (see FIG. 2). This property of the algorithm offers the additional advantage that the user experiences a change in brightness at every step. This improves the user experience.

FIG. 2 shows a graph 200 depicting a dimming curve 202 according to the present disclosure in comparison to a typical dimming curve 201.

Both dimming curves 201, 202 differ due to a different calculation of the current PWM value. The dimming curve 202 according to the present disclosure is calculated by means of a simple approximation with initial modification. In the classic logarithmic characteristic curve 201, the calculation is carried out by determining the logarithmic or exponential time curve which is computationally and memory-intensive.

The dimming curve 202 results by using the dimming parameters a, b, and c described above. The dimming curve 202 is an exemplary dimming curve for a 10-bit PWM. That means that the parameter b is equal to 1023 or is in the range from 1023, for example 50% to 100% or preferably 80% to 100% of 1023, as the number of bits for a 10-bit PWM is equal to (2 to the power of 10) minus 1, that is to say equal to 1023.

The dimming parameter a corresponds to the maximum brightness change between two time steps. The two dimming steps that lead to a maximum brightness change are the last two dimming steps according to FIG. 2, that is to say the dimming steps 216 and 217 in the example in FIG. 2. A change in the PWM value, that is the brightness, of a=16 can be read from the dimming curve 202.

The third dimming parameter c is determined from a and b by the following relationship: c=log 2(b/a)=log 2(1024/16)=8 or is within a range around this value, for example within 50% to 150% or preferably 80% to 120% of this value. It is understood that FIG. 2 shows only an exemplary dimming curve 202. For other PWM drivers, different dimming parameters a, b, and c result.

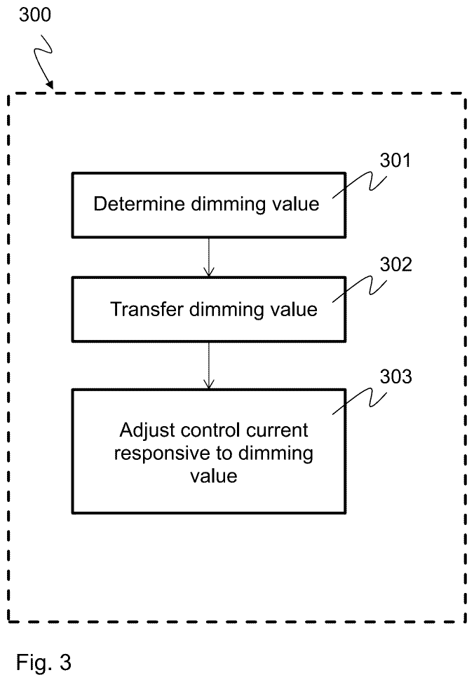

FIG. 3 schematically shows a method 300 according to the present disclosure for dimming a lighting device 100 for vehicle interior lighting.

The method 300 serves to dim a lighting device 100 for vehicle interior lighting with at least one dimmable light source 105 and a current driver 104 for supplying the at least one dimmable light source 105 with a control current 106 with which the at least one light source 105 assumes a brightness which corresponds to the control current 106, as described, for example, above with respect to FIG. 1A.

The method 300 includes the determination 301 of a dimming value 107 for dimming the at least one light source 105, as described, for example, above with respect to FIG. 1A.

The method 300 includes the transfer 302 of the dimming value 107 to the current driver 104, as described for FIG. 1A above, for example.

The method 300 includes the adjustment 303 of the control current 106 for supplying the at least one light source 105 by the current driver 104 in response to the dimming value 107, so that the at least one light source 105 assumes a brightness corresponding to the dimming value 107, wherein the determination 301 of the new dimming value 107 is based on a current dimming value 107b and a dimming value change 107c, wherein the dimming value change 107c is based on a dimming request signal 102, such as described above with respect to FIG. 1A.

Further, a computer program including a program code for executing the method 300 on a lighting device having a microcontroller and a current driver, such as described above can be provided.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components (e.g., op amp circuit integrator as part of the heat flux data module) that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A lighting device for vehicle interior lighting, comprising:
at least one dimmable light source;
a current driver configured to supply the at least one dimmable light source with a control current, the at least one dimmable light source having a brightness corresponding to the control current; and
a microcontroller configured to determine a dimming value to dim the at least one dimmable light source in response to a dimming request signal, the microcontroller configured to transfer the dimming value to the current driver,
wherein the current driver is configured to adjust the control current based on the dimming value, the at least one dimmable light source includes a brightness corresponding to the dimming value, and the microcontroller is configured to determine the dimming value as a new dimming value based on a current dimming value and a dimming value change, with the dimming value change based on the dimming request signal.

2. The lighting device according to claim 1, wherein the microcontroller is configured to determine the new dimming value when the dimming request signal is given, the new dimming value differs from the current dimming value and causes a change in brightness of the at least one dimmable light source, and the change in brightness is perceptible by a user.

3. The lighting device according to claim 2, wherein the dimming value follows a non-logarithmic time curve.

4. The lighting device according to claim 1, wherein the dimming value change is based on at least one of addition and subtraction, and bit shifting.

5. The lighting device according to claim 1, wherein the dimming value change comprises integer changes of the dimming value in a positive or negative direction.

6. The lighting device according to claim 1, wherein the microcontroller is configured to determine the dimming value change based on the current dimming value and one or more predefined dimming value parameters.

7. The lighting device according to claim 6, wherein the microcontroller is configured to determine the dimming value change and the new dimming value based on the following relationships:
$$Δ s ( t ) = a - ( ( b - dimming value ( t ) ) ≫ c ) ,$$
$$Dimming value ( t + 1 ) = dimming value ( t ) \pm Δ s ( t , )$$
wherein “dimming value (t)” denotes the current dimming value, “dimming value (t+1)” denotes the new dimming value, “Δs(t)” denotes the dimming value change, “a”, “b”, and “c” denote the one or more predefined dimming value parameters, and wherein “>>” denotes a right shift by a number of c bits.

8. The lighting device according to claim 7, wherein parameter a corresponds to a predefined maximum global brightness change between two dimming steps, parameter b is within a range of a predefined maximum dimming value, and parameter c is in a range around a value of c=log 2(b/a).

9. The lighting device according to claim 1, wherein the current driver is configured to adjust the control current for supplying the at least one dimmable light source based on pulse width modulation and a portion of an on phase at a total time is determined by the new dimming value.

10. The lighting device according to claim 1, wherein the current driver is configured to adjust the control current for supplying the at least one dimmable light source according to a linear constant current control, and wherein an amplitude of the control current is based on the dimming value.

11. The lighting device according to claim 1, wherein the dimming request signal comprises a start signal and wherein the microcontroller is configured to determine a new dimming value in response to the start signal.

12. The lighting device according to claim 11, wherein the start signal indicates dimming in a positive direction or a negative direction, the microcontroller is configured to determine the new dimming value based on the current dimming value and a positive dimming value change when dimming in the positive direction is indicated, and to determine the new dimming value based on the current dimming value and a negative dimming value change when dimming in the negative direction is indicated.

13. The lighting device according to claim 1, wherein the dimming request signal comprises a stop signal and the microcontroller is configured to leave the current dimming value unchanged in response to the stop signal.

14. The lighting device according to claim 1, wherein the dimming request signal comprises information about a proportional brightness level with respect to a maximum brightness of the at least one dimmable light source, the microcontroller is configured to determine the new dimming value corresponding to the proportional brightness level and the at least one dimmable light source comprises one or more light-emitting diodes.

15. The lighting device according to claim 1, wherein the at least one dimmable light source comprises one or more light-emitting diodes.

16. The lighting device according to claim 1, wherein the lighting device is configured to receive the dimming request signal from an external source via a switch, a button, a user interface with a display, or via a signal line.

17. The lighting device according to claim 1, further comprising an integrated sensor system configured to collect user input via at least one of a button, a switch, an integrated proximity sensor system, touch sensor system, and a force sensor system, and to transform the user input into the dimming request signal.

18. A method to dim a lighting device for vehicle interior lighting including at least one dimmable light source and a current driver for supplying the at least one dimmable light source with a control current with which the at least one dimmable light source has a brightness that corresponds to the control current, wherein the method comprises:
determining a dimming value for dimming the at least one dimmable light source;
transferring the dimming value to the current driver;
adjusting the control current based on the dimming value, so that the at least one dimmable light source has the brightness that corresponds to the dimming value; and
determining a new dimming value based on a current dimming value and a dimming value change, and the dimming value change is based on a dimming request signal.
